(19) United States
(12) Patent Application Publication
(10) Pub. No.: US 2014/0209591 A1
(43) Pub. Date: Jul. 31, 2014

(54) BOX HEATER SYSTEM

(71) Applicant: Walkin On Down Ltd., Stratford (CA)

(72) Inventor: John David Swan, Stratford (CA)

(73) Assignee: WALKIN ON DOWN LTD., Stratford (CA)

(21) Appl. No.: 14/164,387

(22) Filed: Jan. 27, 2014

Related U.S. Application Data
(60) Provisional application No. 61/756,497, filed on Jan. 25, 2013.

(51) Int. Cl. H05B 3/00

(52) U.S. Cl. CPC B60P 1/283
USPC 219/200

(57) ABSTRACT

A box heater system to be mounted in a box in which material is receivable for discharge therefrom. The box heater system includes a heat-generating assembly having a body including one or more channels formed therein, and one or more heating elements at least partially positioned in the channel(s), for generating heat and transferring the heat to at least part of the body. The body is movable relative to the heating element, and the heating element is movable relative to the body. The heat transferred to the body is at least partially transferable to the material received in the box.

This application claims the benefit of U.S. Provisional Patent Application No. 61/756,497, filed on Jan. 25, 2013, the disclosure of which is fully incorporated herein by reference.

### FIELD OF THE INVENTION

The present invention is a box heater system to be mounted in a box in which material is receivable for discharge therefrom.

### BACKGROUND OF THE INVENTION

In cold climates, material that is positioned in a metal box (e.g., on a truck) may freeze temporarily in the box, or be frozen when it is put in the box, causing various material handling problems.

For instance, aggregate put into a truck box may freeze to the box. In this situation, raising the box can be dangerous, because the raised box is unstable. Removal of a frozen load usually requires that the truck be heated, e.g., in a heated garage, until the material thaws. The truck is then driven to the work site for dumping the material before it refreezes in the box. These additional steps add significant costs.

Due to these problems, much outdoor work ceases during the winter months in the parts of the world subjected to sub-freezing temperatures for extended periods of time.

There are many other situations where material freezes to a metal box. For instance, in municipal garbage trucks, the municipal waste can freeze to the box, so that the waste cannot be removed from the box. This results in extra costs incurred in connection with heating the garbage truck, as described above.

### SUMMARY OF THE INVENTION

There is a need for a box heater system that overcomes or mitigates one or more of the disadvantages or defects of the prior art. Such disadvantages or defects are not necessarily included in those described above.

In its broad aspect, the invention provides a box heater system to be mounted in a box in which material is receivable for discharge therefrom. The box heater system includes a heat-generating assembly having a body at least partially defined by substantially planar opposed first and second surfaces. The body includes one or more channels formed in the second surface, and the body is securable to the box. The heat-generating assembly also includes one or more heating elements at least partially positioned in the channel(s), for generating heat and transferring the heat to at least part of the body. The body is movable relative to the heating element, and the heating element is movable relative to the body. The heat transferred to the body is at least partially transferable to the material received in the box.

In another aspect, the box heater system also includes an insulation subassembly positionable between the box and the body, to impede transfer of the heat generated by the heating element to the box.

In yet another aspect, the box heater system also includes a liner positionable on the first surface of the body for engagement with the material received in the box, to at least partially protect the body from deformation by the material received in the box.

In another of its aspects, the invention provides a heat-generating assembly to be mounted in a box in which material is receivable for discharge therefrom. The heat-generating assembly includes a body at least partially defined by substantially planar opposed first and second surfaces, the body having one or more channels formed in the second surface. The body is securable to the box. The heat-generating assembly also includes one or more heating elements at least partially positioned in the channel, for generating and transferring heat to at least part of the body. The body is movable relative to the heating element, and the heating element is movable relative to the body. The heat transferred to the body is at least partially transferable to the material received in the box.

In yet another aspect, the invention provides a box in which material is receivable for discharge therefrom. The box includes one or more walls at least partially defining a cavity in which the material is receivable. The box also includes a box heater system having a heat-generating assembly. The heat-generating assembly includes a body at least partially defined by substantially planar opposed first and second surfaces, the body having one or more channels formed in the second surface. The body is securable to the wall(s). The heat-generating assembly also includes one or more heating elements at least partially positioned in the channel(s), for generating and transferring heat to at least part of the body. The body is movable relative to the heating element, and the heating element is movable relative to the body. The heat transferred to the body is at least partially transferable to the material received in the box.

### BRIEF DESCRIPTION OF THE DRAWINGS

The invention will be better understood with reference to the attached drawings, in which:

FIG. 1 is a block diagram schematically illustrating an embodiment of a box heater system of the invention;

FIG. 2 is a top view of an embodiment of the box heater system of the invention, mounted in a box;

FIG. 3 is a longitudinal cross-section of a portion of an embodiment of the box heater system of FIGS. 1 and 2 mounted in a box, drawn at a larger scale;

FIG. 4 is a longitudinal cross-section of an embodiment of a heat-generating assembly of the invention, drawn at a larger scale;

FIG. 5 is a cross-section of the heat generating assembly of FIG. 4, drawn at a larger scale; and

FIG. 6 is a cross-section of another embodiment of the heat generating assembly of the invention.

### DETAILED DESCRIPTION

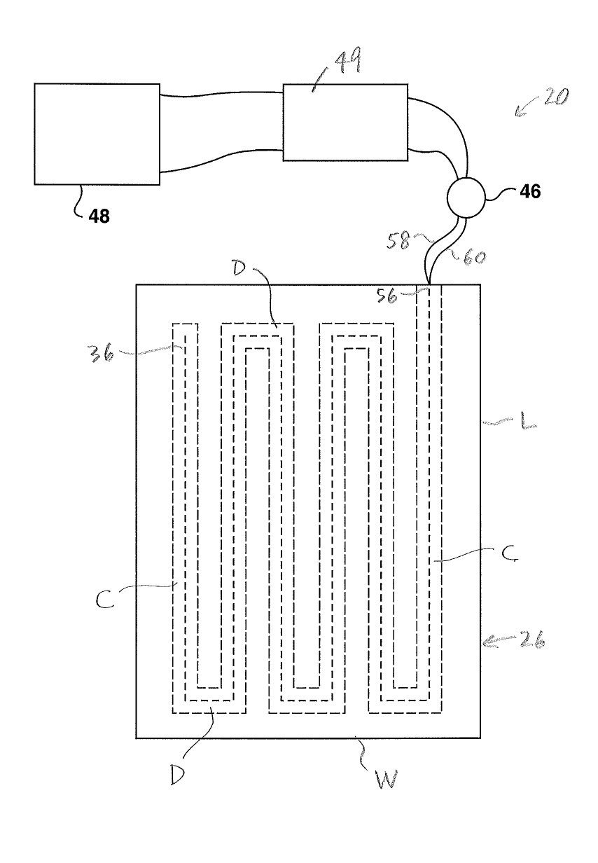

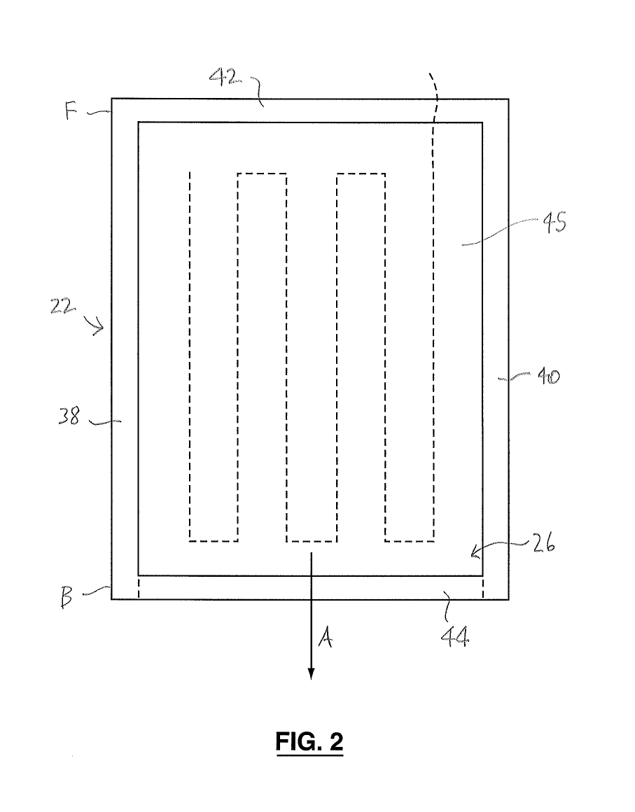

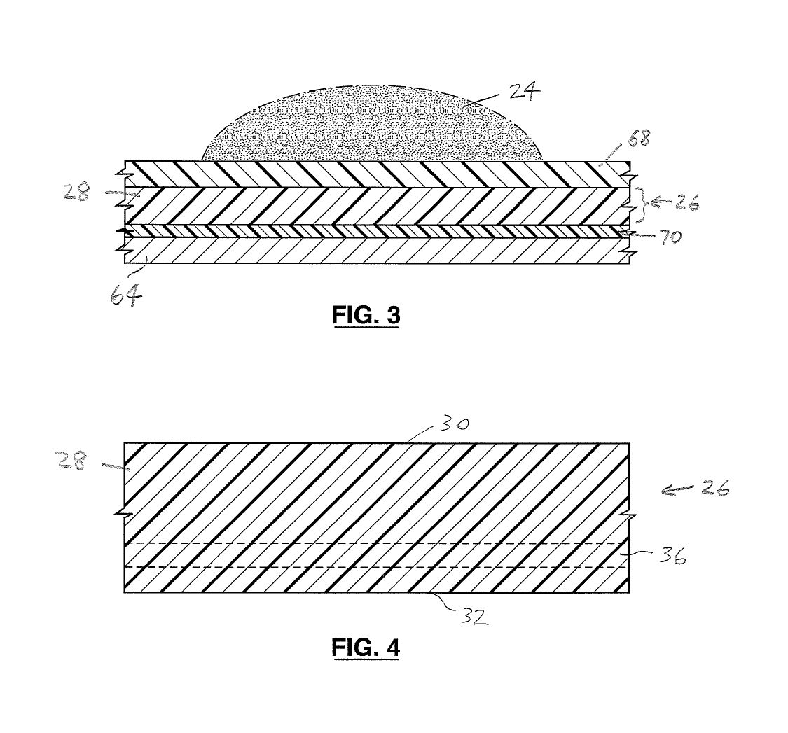

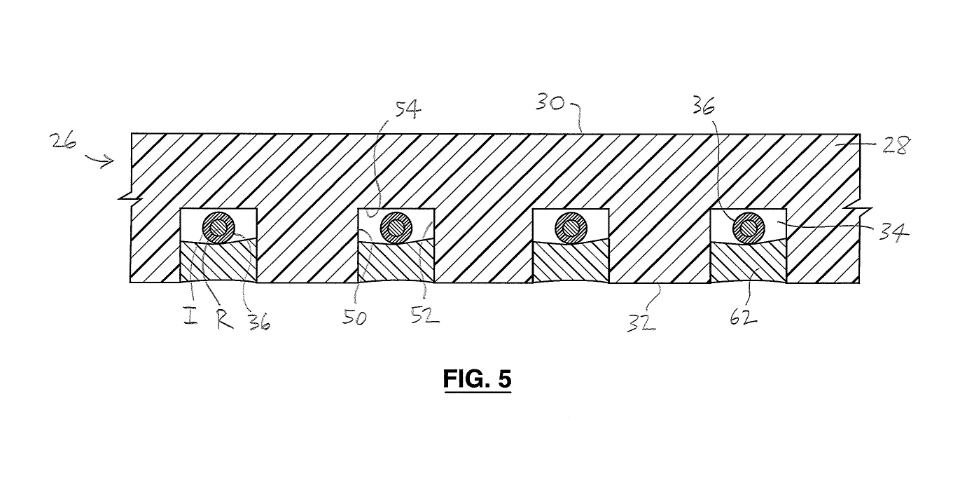

In the attached drawings, like reference numerals designate corresponding elements throughout. Reference is first made to FIGS. 1-5 to describe an embodiment of a box heater system of the invention referred to generally by the numeral 20. As will be described, the box heater system 20 preferably is mounted in a box 22 (FIG. 2) in which material 24 (FIG. 3) is receivable for discharge therefrom. In one embodiment, the box heater system 20 preferably includes a heat-generating assembly 26. An embodiment of the heat-generating assembly 26, illustrated in FIGS. 4 and 5, preferably includes a body 28 at least partially defined by substantially planar opposed first and second surfaces 30, 32, the body 28 including one or more channels 34 formed in the second surface 32. It is preferred that the body 28 is securable to the box 22. Preferably, the heat-generating assembly 26 also includes one or more heating elements 36 at least partially positioned in the channel(s) 34, for generating and transferring heat to at least part of the body 28. As will also be described, the heating element 36 preferably is movable relative to the body 28, and the body 28 preferably is also movable relative to the heating element 36. Preferably, the heat transferred to the body 28 is at least partially transferable to the material 24 received in the box 22. [claim 1] The box 22 preferably is mounted in a truck (not shown).

It will be understood that the material 24 is omitted from FIGS. 1 and 2 for clarity of illustration. As can be seen in FIG. 2, the box 22 preferably has side walls 38, 40 thereof joined by a front wall 42. The side walls 38, 40 are also joined by a movable (or openable) gate 44 at a back end “B” of the box. The walls 38, 40, 42 and the gate 44 partially define a cavity 45 in the box 22. After the gate 44 is secured (i.e., closed), the material 24 is dumped into the box 22. If the box 22 is mounted on a gravel or dump truck, the material 24 may be any excavated material (e.g., one or more of sand and gravel, rocks, soil, and/or other debris). As is known, the body 28 is subjected to dynamic loading of the material, and static loading while the material is in the box. The material 24 typically has a substantial water content. Once the material 24 is in the box 22, it is warmed by the box heater system 20 sufficiently that the water included in the material 24 that is proximal to the body 28 does not freeze. Because of the heat transferred to the material (and to the water included therein) proximal to the body 28 from the box heater system 20, the material 24 does not freeze to the box 22. The material 24 preferably is removed from the box 22 by raising the box 22 at its front end “F” and allowing the gate 44 to open, so that the material 24 exits the raised box 22 at the back end “B” through the opened gate 44, in the direction indicated by arrow “A” in FIG. 2. Accordingly, in cold weather, the removal of the material 24 from the box is possible due to the heat transferred from the box heater system 20 to the material 24.

It will be understood that the box 22 illustrated in FIG. 2 is exemplary only, and that the box heater system 20 may be installed in a variety of boxes or receptacles, for use with a variety of materials. For example, the box may be a receptacle portion of a municipal waste collection vehicle (not shown), i.e., a garbage truck. The material (i.e., household waste, in this example) may contain significant amounts of water. The box heater system installed in the garbage truck prevents the freezing of the water included in the material proximal to the system, so that the garbage does not freeze to the receptacle portion of the garbage truck.

In another example, in a box having a conveyor in a “live bottom”, the heat-generating assembly 26 is mounted on parts of the box sloped toward the conveyor.

In one embodiment, the heating element 36 generates heat upon electric current being passed therethrough and the box heater system 20 preferably additionally includes a controller 46 (FIG. 1) for controlling the electric current. [claim 2] The electrical power for the system 20 preferably is provided by any suitable power source 48 (FIG. 1). In one embodiment, the electrical power preferably is provided by an electrical system (not shown) of the truck on which the box 22 is mounted, as will be described.

The heating element 36 preferably is any suitable heat-generating device, e.g., a resistive heating element. In one embodiment, it has been found that a conventional heating cable manufactured for use in a floor inside a building to provide “radiant heating” is suitable. Advantageously, such a heating cable provides a suitable amount of heat, and can be used in the box heater system 20, to provide a suitable amount of heat. Also, the heating cable is well insulated, and therefore is unlikely to be affected by water. In FIG. 5, the heating element 36 is illustrated as including a conductive metal core “R” and electrical insulation “I” around the core “R”. The heating cable is also conventionally grounded. It has been found that a heat cable having gauges between 18 and 24, manufactured by Danfoss or Stelpro, is suitable. The larger gauge is used in the larger body size.

Those skilled in the art would appreciate that the heating element 36 may be operable with DC or AC power. In one embodiment, the electrical power for the heating element 36 preferably is generated by the engine of the vehicle and/or provided by the vehicle's battery (and/or by supplemental batteries). Those skilled in the art would appreciate that other controls or devices may be needed, e.g., an appropriate inverter (i.e., for conversion of DC power to AC power) may be required. The conventional heating cable described above requires AC power. For instance, where the heating element 36 is manufactured for use with AC power, the system 20 preferably includes an inverter 49 (FIG. 1), to convert the DC power provided by the truck's electrical system (i.e., its battery and generator/alternator) to AC power suitable for the heating element 36.

The body 28 may be in any suitable configuration, and may be made of any suitable material(s). In one embodiment, the body 28 preferably is made of a generally flexible and resilient material that is sufficiently strong that it remains substantially resilient and flexible over a wide range of temperatures. It has been found that certain types of polyethylene (e.g., HMWPE, or UHMWPE) are suitable.

It is also preferred that the body 28 is relatively thin, e.g., about ⅜ inch (0.375 inch, or approximately 0.95 cm). As can be seen in FIG. 5, on one side of the body 28, the channels 34 are provided. Each of the channels 34 is sufficiently large to receive at least part of the heating element 36.

As can be seen in FIGS. 1 and 2, in one embodiment, the body 28 is generally rectangular in shape (due to the shape of the box in which the body is intended to fit), and preferably is defined by longer sides “L” and shorter sides “W” orthogonal thereto. (It will be understood that certain parts of the box heater system 20 are omitted from FIGS. 1 and 2 for clarity of illustration.) Those skilled in the art would appreciate that the channels 34 may be formed in the body in any suitable arrangement. In one embodiment, and as can be seen in FIG. 1, the channels 34 preferably include one or more lengthwise channels “C” that are substantially parallel to the lengthwise sides “L” of the body, and one or more crosswise channels “D” that are substantially parallel to the shorter sides “W” of the body 28. It will be understood that the channels are exaggerated in size in FIG. 1, and that only certain of the channels are shown in FIG. 1, for clarity of illustration.

As can be seen in FIG. 5, in one embodiment, the channels 34 preferably are formed in the second surface 32 of the body 28. This may conveniently be done while the body 28 rests on the first surface 30. In one embodiment, the channel 34 preferably is defined by sidewalls 50, 52 and a roof 54 (FIG. 5). As can be seen in FIG. 5, in one embodiment, the heating element 36 preferably is not secured to the sidewalls 50, 52 or the roof 54.

Preferably, after the channels 34 are formed in the body 28, the heating element 36 is positioned therein. As can be seen in FIG. 5, in one embodiment, the heating element 36 preferably is located by the channels 34 so that the heating element 36 extends across substantially the entire body 28, with a view to distributing heat generated thereby relatively evenly across the body 28. The connection of the heating element 36 to the power source 48 and the controller 46 is conventional. In one embodiment, at one end 56 of the heating element 36, two wires (identified as 58 and 60 in FIG. 1) extend from the heating element 36, to permit connection thereof ultimately to the power source 48, i.e., to the truck's electrical circuit. As can be seen in FIG. 1, in one embodiment, the wires 58, 60 preferably are directly connected to the thermostat 46.

Once the heating element 36 is positioned at least partially in the channel, the heating element 36 preferably is held therein using any suitable means that permits movement of the heating element 36 relative to the body 28, and vice versa. Those skilled in the art would appreciate that the heating element 36 preferably is sealed in the channel(s) 34, i.e., generally not exposed to water. In one embodiment, the heat-generating assembly 26 preferably includes plug element(s) 62 for at least partially sealing the heating element 36 in the channel(s) 34. [claim 6] In one embodiment, the plug element 62 preferably is plastic that is “plastic welded” to the sidewalls 50, 52 of the channel 34. Preferably, the plug element 62 is made of the same material as the body 28. Other suitable means for locating the heating element 36 in the channel 34 would occur to those skilled in the art. The plug element 62 preferably is plastic welded to the sidewalls 50, 52 in order to protect the heating cable 36 from water. Those skilled in the art would appreciate that water in the box tends to infiltrate beneath the body 28.

It will be understood that, in the embodiment illustrated in FIG. 5, the heating element 36 preferably is not secured to the plug element 62. This permits relative movement between the heating element 36 and the body 28. When the plug element 62 is first put in place in the channel 34, the plug element 62 is at an elevated temperature, and in a substantially liquid state, although viscous. However, the plug element 62 preferably is heated only to the extent that it cools (and solidifies) before the plug element 62 engages the heating element, in order that the heating element 36 may not become secured to the plug element 62.

It will be understood that the body 28 preferably is secured to a bottom wall 64 (FIG. 3) of the box 22 in any suitable manner. The bottom wall 64 is attached to the side walls 38, 40 and the front wall 42, as is conventional. When the gate 44 is closed, it at least partially engages the bottom wall 64, in a conventional manner. The body 28 preferably is secured to the bottom wall 64 by a number of fasteners (not shown) that are spaced apart from each other.

As noted above, it is preferred that the heating element 36 is movable relative to the body 28, and the body 28 also is movable relative to the heating element 36. (The movement of the body 28 is relatively small, and generally in the vertical direction.) Accordingly, when the heating element 36 is positioned in the channels 34, it is preferably not secured to the sidewalls 50, 32 or the roof 54. It is believed that, because of this, the body 28 is permitted to move in response to the load imposed by the material 24 on the body 28 (and the removal of such load) without materially damaging the heating element 36. Such movement would be generally substantially vertical (i.e., generally orthogonal relative to the body 28), due to the loading of the material into the box, and also its unloading.

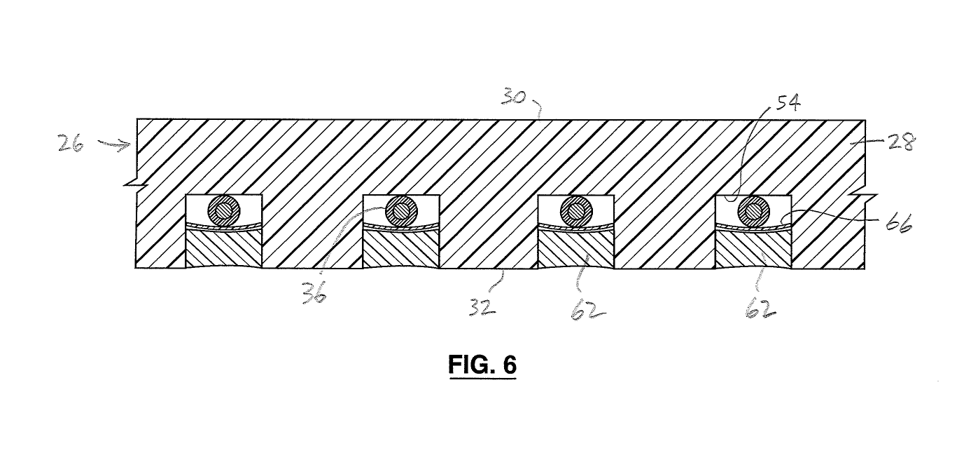

As can be seen in FIG. 5, in one embodiment, there is a small gap between the roof 54 and the heating element 36. In an alternative embodiment illustrated in FIG. 6, the heating element 36 preferably is slidably engaged with the roof 54 of the channel 34.

As shown in FIG. 6, in an alternative embodiment, the heating element 36 preferably is held against the roof 54 by a bracket 66. The bracket 66 preferably is positioned in the channel 34 to slidably engage the heating element 36 with the roof 54, to permit movement of the heating element 36 relative to the body 28, and vice versa. It will be understood that the bracket 66 does not hold the heating element 36 tightly, or securely, against the roof 54.

Those skilled in the art would appreciate that the bracket 66 may be in any suitable form. In the embodiment illustrated in FIG. 6, the bracket 66 is a hard plastic clip. It will be understood that the bracket 66 may or may not be continuous along a length of the channel(s) 34, as the case may be. Those skilled in the art would appreciate that the bracket 66 preferably is positioned in the channel 34 after the heating element 36 is located in the channel 34, and before the plug element 62 is secured to the sidewalls 50, 52. Accordingly, in one embodiment, the heating element 36 preferably is engaged with one or more surfaces 50, 52, 54 defining the channel for transfer of the heat generated by the heating element by conduction to the body. [claim 7]

In one embodiment, where it is anticipated that there may be a relatively large weight of the material dynamically loaded, the body 28 may be formed by a slab of plastic that is approximately ½ inch (approximately 1.27 cm) thick. In this situation, the channels are formed to be about ⅜ inch (approximately 0.95 cm) deep, leaving a thickness of approximately ⅛ inch (approximately 0.32 cm) between the channel 34 and the first surface 30.

In one embodiment, it is also preferred that the box heater system 20 additionally includes a liner 68 (FIG. 3) positionable on the first surface 30 of the body 28 for engagement with the material 24 received in the box 22, to at least partially protect the body 28 from deformation by the material received in the box 22. [claim 5] Preferably, the liner 68 is approximately ½ inch (approximately 1.27 cm) thick, and made of ultra-high-molecular-weight polyethylene (UHMW). The liner 68 is to resist deformation of the body 28 by the material 24, particularly deformation that would occur (in the absence of the liner) due to dynamic loading of the material, e.g., the dynamic loading that occurs when the material 24 is dumped into the box 22. The liner 68 is included in order to provide protection to the heat-generating assembly 26.

As described above, the controller 46 preferably includes a thermostat for controlling the electric current supplied to the heating element 36 based on a preselected temperature. [claim 3] Any suitable thermostat may be used. Preferably, the thermostat includes a gas probe that is welded to the liner 68, and located at least partially inside the liner 68. The thermostat enables the operator to adjust the heat provided by the heating element 36 based on, for instance, weather conditions.

In one embodiment, the box heater system 20 preferably also includes an insulation subassembly 70 (FIG. 3) positionable between the box 22 and the body 28, to impede transfer of the heat generated by the heating element 36 to the box 22. [claim 4] As can be seen in FIG. 3, it is preferred that the insulation subassembly 70 is positioned between the body 28 and the bottom wall 64 of the box 22. Preferably, the second surface 32 of the body 28 engages the insulation subassembly 70.

The insulation subassembly 70 preferably includes one or more sheets of any suitable thermally insulating material, or materials. It has been found that insulating material developed for use with flooring in a basement, e.g., hardwood flooring, is suitable. Those skilled in the art would be aware of other suitable insulating material(s).

In use, the box heater system 20 is activated via the controller when the ambient temperature is sufficiently low that the material 24 may freeze in the box 22. Preferably, the operator adjusts the thermostat so that the material does not freeze, and energy consumption is optimized. The material 24, upon its receipt in the box 22, is then sufficiently warmed by the system 20 that the material 24 flows easily out of the box 22 when the gate is opened and the front end “F” of the box is lifted.

It will be appreciated by those skilled in the art that the invention can take many forms, and that such forms are within the scope of the invention as described above. The scope of the claims should not be limited by the preferred embodiments set forth in the examples, but should be given the broadest interpretation consistent with the description as a whole.

I claim:

1. A box heater system to be mounted in a box in which material is receivable for discharge therefrom, the box heater system comprising:
a heat-generating assembly comprising:
a body at least partially defined by substantially planar opposed first and second surfaces, the body comprising at least one channel formed in the second surface;
the body being securable to the box;
at least one heating element at least partially positioned in said at least one channel, for generating heat and transferring the heat to at least part of the body;
the body being movable relative to said at least one heating element;
said at least one heating element being movable relative to the body; and
the heat transferred to the body being at least partially transferable to the material received in the box.

2. A box heater system according to claim 1 in which said at least one heating element generates heat upon electric current being passed therethrough and the box heater system additionally comprises a controller for controlling said electric current.

3. A box heater system according to claim 2 in which the controller includes a thermostat for controlling said electric current based on a preselected temperature.

4. A box heater system according to claim 1 additionally comprising an insulation subassembly positionable between the box and the body, to impede transfer of the heat generated by said at least one heating element to the box.

5. A box heater system according to claim 1 additionally comprising a liner positionable on the first surface of the body for engagement with the material received in the box, to at least partially protect the body from deformation by the material received in the box.

6. A box heater system according to claim 1 in which the heat-generating assembly additionally comprises at least one plug element for at least partially sealing said at least one heating element in said at least one channel.

7. A box heater system according to claim 6 in which said at least one heating element is engaged with at least one surface defining said at least one channel for transfer of the heat generated by said at least one heating element by conduction to the body.

8. A heat-generating assembly to be mounted in a box in which material is receivable for discharge therefrom, the heat-generating assembly comprising:
a body at least partially defined by substantially planar opposed first and second surfaces, the body comprising at least one channel formed in the second surface;
the body being securable to the box;
at least one heating element at least partially positioned in said at least one channel, for generating heat and transferring the heat to at least part of the body;
the body being movable relative to said at least one heating element;
said at least one heating element being movable relative to the body; and
the heat transferred to the body being at least partially transferable to the material received in the box.

9. A heat-generating assembly according to claim 8 in which said at least one heating element generates heat upon electric current being passed therethrough and the box heater system additionally comprises a controller for controlling said electric current.

10. A heat-generating assembly according to claim 9 in which the controller includes a thermostat for controlling said electric current based on a preselected temperature.

11. A box in which material is receivable for discharge therefrom, the box comprising:
at least one wall at least partially defining a cavity in the box in which the material is receivable;
a box heater system comprising a heat-generating assembly, the heat-generating assembly comprising:
a body at least partially defined by substantially planar opposed first and second surfaces, the body comprising at least one channel formed in the second surface;
the body being securable to said at least one wall;
at least one heating element at least partially positioned in said at least one channel, for generating heat and transferring the heat to at least part of the body;
the body being movable relative to said at least one heating element;
said at least one heating element being movable relative to the body; and
the heat transferred to the body being at least partially transferable to the material received in the box.

12. A box according to claim 11 in which said at least one heating element generates heat upon electric current being passed therethrough and the box heater system additionally comprises a controller for controlling said electric current.

13. A box according to claim 12 in which the controller includes a thermostat for controlling said electric current based on a preselected temperature.

14. A box according to claim 11 additionally comprising an insulation subassembly positionable between said at least one wall and the body, to impede transfer of the heat generated by said at least one heating element to said at least one wall.

15. A box according to claim 14 in which the body is secured to said at least one wall with the second surface thereof facing toward said at least one wall.

16. A box according to claim 11 additionally comprising a liner positionable on the body for engagement with the material received in the box, to at least partially protect the body from deformation by the material received in the box.

17. A box according to claim 11 in which the heat-generating assembly additionally comprises at least one plug element for at least partially sealing said at least one heating element in said at least one channel.

18. A box according to claim 17 in which said at least one heating element is engaged with at least one surface defining said at least one channel for transfer of the heat generated by said at least one heating element by conduction to the body.
